(19) United States
(12) Patent Application Publication
(10) Pub. No.: US 2026/0223865 A1
(43) Pub. Date: Aug. 6, 2026

(54) DOUGH PRESSING MACHINE

(71) Applicant: Shenzhen Saileisi Technology Co., Ltd., Shenzhen (CN)

(72) Inventor: Shengxin ZHANG, Shenzhen (CN)

(21) Appl. No.: 19/324,871

(22) Filed: Sep. 10, 2025

(30) Foreign Application Priority Data
Feb. 6, 2025 (CN) 2025201904331

(51) Int. Cl. A21C 11/10

(52) U.S. Cl. CPC A21C 11/106

(57) ABSTRACT

Disclosed is a dough pressing machine, including an upper cover, a rotating shaft, a lower cover, and an edge pressing structure; the upper cover is rotatably connected to the lower cover via the rotating shaft, the upper cover is capable of rotating relative to the lower cover to cover the lower cover to form a dough pressing chamber; the edge pressing structure is disposed within the dough pressing chamber and includes a first edge-pressing structure and a second edge-pressing structure, the first edge-pressing structure and the second edge-pressing structure are disposed at an interval, and the second edge-pressing structure is detachably mounted on the upper cover and/or the lower cover. According to the dough pressing machine of the present disclosure, the second edge-pressing structure is detachably mounted on the upper cover and/or the lower cover. When the dough pressing machine is used by users, the second edge-pressing structure can be mounted and used for edge pressing, and when the second edge-pressing structure is removed, the first edge-pressing structure can be used for edge pressing. Different sizes of dough can thus be pressed; hence, the dough pressing machine is suitable for consumers with different appetites.

### TECHNICAL FIELD

The present disclosure relates to the field of molds, in particular to a dough pressing machine.

### BACKGROUND

Flat-bread is very common in people's lives. A large piece of dough can be pressed into lots of small pieces of dough with fixed shapes, which speeds up the production of small flat-breads for vendors, and ensures neatness, cleanliness, and aesthetics. However, the dough pressing machine in the prior art usually produces small pieces of dough in a uniform size; hence, buyers cannot purchase different sizes of flat-breads according to their individual appetite needs, thereby resulting in food waste or insufficient quantity and leading to poor user's purchase experience.

### SUMMARY

The present disclosure aims to provide a dough pressing machine to solve the problem, i.e., a conventional dough pressing machine produces small pieces of dough in a uniform size, hence, buyers cannot purchase different sizes of flat-breads according to their individual appetite needs, thereby resulting in food waste or insufficient quantity and leading to poor user's purchase experience.

To solve the above technical problem, the present disclosure adopts the following technical solution:

A dough pressing machine, including an upper cover, a rotating shaft, a lower cover, and an edge pressing structure; the upper cover is rotatably connected to the lower cover via the rotating shaft, the upper cover is capable of rotating relative to the lower cover to cover on the lower cover to form a dough pressing chamber, the edge pressing structure is disposed within the dough pressing chamber and includes a first edge-pressing structure and a second edge-pressing structure, the first-edge pressing structure and the second edge-pressing structure are disposed at an interval, and the second edge-pressing structure is detachably mounted on the upper cover and/or the lower cover.

In one embodiment, the edge pressing structure further includes a third edge-pressing structure, and the third edge-pressing structure and the second edge-pressing structure are disposed at an interval.

In one embodiment, the third edge-pressing structure is detachably mounted on the upper cover and/or the lower cover.

In one embodiment, the edge pressing structure is a serrated structure including a first tooth portion disposed on the upper cover and a second tooth portion disposed on the lower cover, and when the upper cover covers on the lower cover, the first tooth portion and the second tooth portion are meshed with each other.

In one embodiment, the edge pressing structure is extended circumferentially along the dough pressing machine, and the serrated structure is extended circumferentially and continuously along the edge pressing structure.

In one embodiment, the first edge-pressing structure, the second-edge pressing structure, and the third edge-pressing structure each include a first block and a second block, one side of the first block close to the second block is a first step structure, one side of the second block close to the first block is a second step structure, and the first block and the second block are disposed in a cooperation manner; the first step structure includes a first tabletop and a second tabletop, the second step structure includes a third tabletop and a fourth tabletop, and when the upper cover covers on the lower cover, the first tabletop is abutted against the third tabletop, and the second tabletop is abutted against the fourth tabletop.

In one embodiment, in the second edge-pressing structure and the third edge-pressing structure, one of the first block and the upper cover is provided with a mounting block, and the other is provided with a mounting groove, the mounting block is capable of being accommodated within the mounting groove such that the first block is detachably mounted on the upper cover; and
one of the second block and the lower cover is provided with a mounting block, and the other is provided with a mounting groove, the mounting block is capable of being accommodated within the mounting groove such that the second block is detachably mounted on the lower cover.

In one embodiment, the upper cover is provided with a first rotating portion, the lower cover is provided with a second rotating portion, the first rotating portion and the second rotating portion are disposed on the same side of the upper cover and the lower cover, one of the first rotating portion and the second rotating portion is provided with a hanger, and the other is provided with a hanging hole, the hanger is clamped with the hanging hole, and the hanger is capable of rotating within the hanging hole such that the upper cover is capable of rotating relative to the lower cover.

In one embodiment, a control portion is disposed on one side of the upper cover away from the first rotating portion for manual operation to rotate and open the upper cover.

In one embodiment, the control portion is provided with a through hole for hanging the dough pressing machine.

According to the above technical solution, the embodiments of the present disclosure at least have the following advantages and positive effects:

The dough pressing machine in the embodiment of the present disclosure includes an upper cover, a rotating shaft, a lower cover, and an edge pressing structure, the edge pressing structure includes a first edge-pressing structure and a second edge-pressing structure, the second edge-pressing structure is detachably mounted on the upper cover and/or the lower cover. When the dough pressing machine is used by users, the second edge-pressing structure can be mounted and used for edge pressing, and when the second edge-pressing structure is removed, the first edge-pressing structure can be used for edge pressing. Different sizes of dough can be pressed, which is thus suitable for consumers with different appetites.

### BRIEF DESCRIPTION OF THE DRAWINGS

To illustrate the technical solutions in the embodiments of the present disclosure or the prior art more clearly, the accompanying drawings required for the description of the embodiments or the prior art will be briefly introduced as follows. Obviously, the accompanying drawings described below are merely some embodiments of the present disclosure. Moreover, those skilled in the art could further obtain other drawings based on the structures shown in these drawings without any inventive efforts.

FIG. 1 is a schematic diagram showing an overall structure of a dough pressing machine according to an embodiment of the present disclosure;

FIG. 2 is a schematic diagram showing a sectional structure of the dough pressing machine as shown in FIG. 1;

FIG. 3 is a structure diagram showing an upper cover of the dough pressing machine as shown in FIG. 1; and

FIG. 4 is a structure diagram showing a lower cover of the dough pressing machine as shown in FIG. 1.

Reference numerals are described as follows:

10, dough pressing machine; 100, upper cover; 110, dough pressing chamber; 120, mounting groove; 130, first rotating portion; 131, hanging hole; 132, control portion; 133, through hole; 200, rotating shaft; 300, lower cover; 310, second rotating portion; 311, hanger; 400, edge pressing structure; 410, first edge-pressing structure; 420, second edge-pressing structure; 421, first block; 422, second block; 423, first step structure; 424, second step structure; 425, first tabletop; 426, second tabletop; 427, third tabletop; 428, fourth tabletop; 429, mounting block; 430, third edge-pressing structure; 440, serrated structure; 441, first tooth portion; 442, second tooth portion.

### DETAILED DESCRIPTION OF THE EMBODIMENTS

Typical embodiments embodying the features and advantages of the present disclosure will be described in detail in the following description. It should be understood that the present disclosure may be subject to various changes in different embodiments, all of which fall within the scope of the present disclosure, and the description and illustrations herein are essentially for explanatory purposes but shall be not construed as limiting the present disclosure.

Furthermore, the terms “first” and “second” are only for descriptive purposes and shall not be construed as indicating or implying relative importance or implying the number of technical features indicated. Accordingly, features defined as “first” or “second” may expressly or implicitly include one or more of the features. In the description of the present application, the term “a plurality of” means two or more, unless otherwise specified expressly and specifically.

In the description of the present application, it should be noted that unless otherwise specified and defined expressly, the terms “dispose”, “connect”, and “couple” should be understood in a broad sense. For example, it may be a fixed connection, a detachable connection, or an integral connection; it may be a mechanical connection or an electrical connection; it may be a direct connection or an indirect connection via an intermediary; or it may be an internal communication between two components. Those skilled in the art may understand the specific meanings of the above terms in the present application according to specific circumstances.

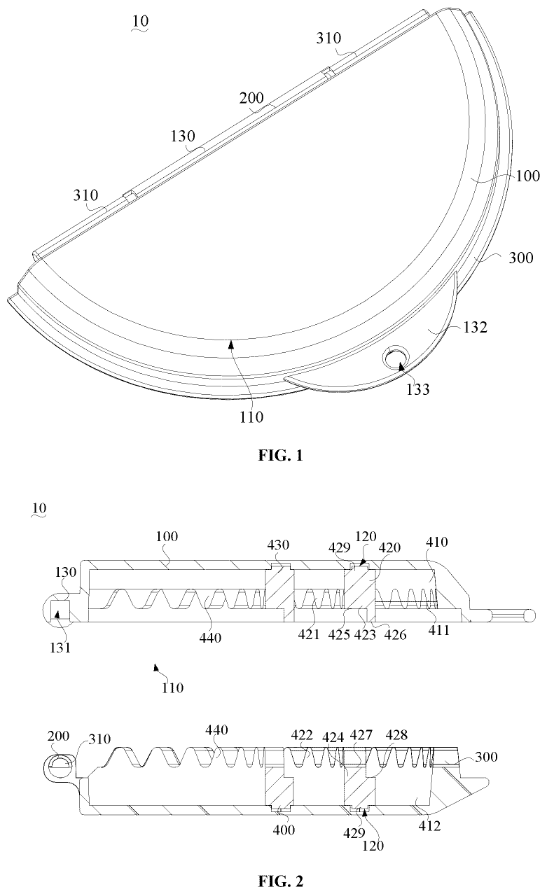

Please referring to FIG. 1 first, the present disclosure provides a dough pressing machine 10 for pressing different sizes of dough pieces. Users can press a dough into different sizes of dough pieces according to their needs to meet different appetite needs of different crowds, thereby avoiding food waste or insufficient quantity.

Referring to FIGS. 1 and 2, the dough pressing machine 10 includes an upper cover 100, a rotating shaft 200, and a lower cover 300. The upper cover 100 is rotatably connected to the lower cover 300 via the rotating shaft 200, and the upper cover 100 is capable of rotating relative to the lower cover 300 to cover on the lower cover 300, thereby forming a dough pressing chamber 110. The lower cover 300 is configured for placement on a tabletop, convenient for consumer use.

It should be noted that an anti-slip layer is disposed on one side of the lower cover 300 away from the upper cover 100, and is configured to increase a frictional force between the lower cover 300 and the table surface, such that the dough pressing machine 10 is free of moving relative to the tabletop when in use. It can be understood that the anti-slip layer may also not be configured as long as the dough pressing machine 10 may be placed on the tabletop, such solutions should be protected.

Referring to FIG. 2, the dough pressing machine 10 further includes an edge pressing structure 400 disposed inside the dough pressing chamber 110. The edge pressing structure 400 may press a large piece of dough placed inside the pressing chamber 110 into small pieces of dough with the same shape and size as the edge pressing structure 400.

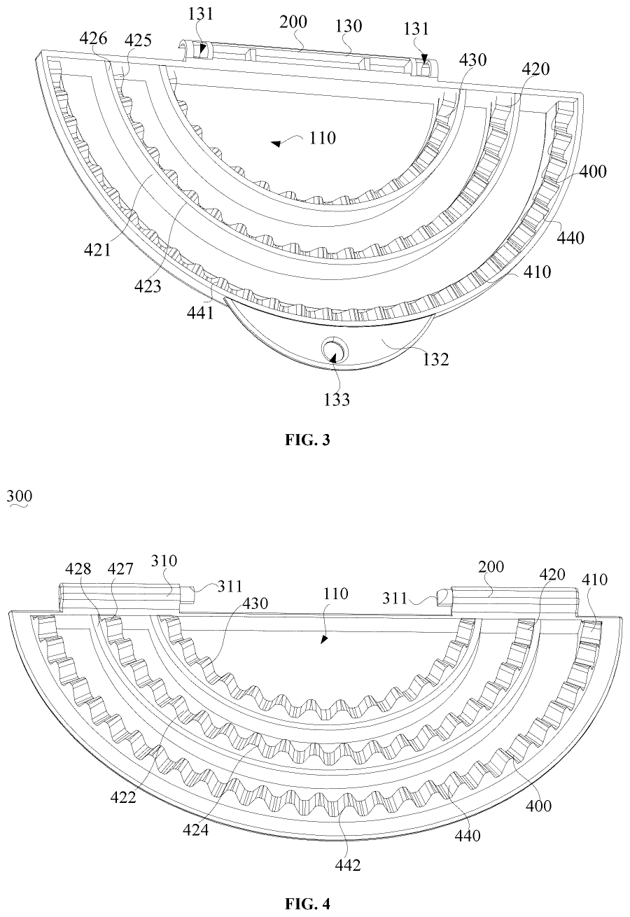

Referring to FIGS. 3 and 4, it should be noted that the edge pressing structure 400 includes a first edge-pressing structure 410 and a second edge-pressing structure 420 that are disposed at an interval. The first edge-pressing structure 410 is disposed at an edge of the pressing chamber 110, and the small pieces of dough pressed by the first edge-pressing structure 410 are of the same size as the pressing chamber 110; the second edge-pressing structure 420 is disposed within the dough pressing chamber 110, and the small pieces of dough pressed by the second edge-pressing structure 420 are smaller than those pressed by the first edge-pressing structure 410 in size.

It should be noted that, in this embodiment, the second edge-pressing structure 420 is detachably connected to the upper cover 100 and the lower cover 300.

It should be noted that, in other embodiments, the second edge-pressing structure 420 is detachably connected to the upper cover 100.

It should be noted that, in other embodiments, the second edge-pressing structure 420 is detachably connected to the lower cover 300.

To sum up, in the present application, the dough pressing machine 10 includes an upper cover 100, a rotating shaft 200, a lower cover 300, and an edge pressing structure 400. The edge pressing structure 400 includes a first edge-pressing structure 410 and a second edge-pressing structure 420, and the second edge-pressing structure 420 is detachably mounted on the upper cover 100 and/or the lower cover 300. When the dough pressing machine 10 is used by users, the second edge-pressing structure 420 can be mounted and used for edge pressing, and when the second edge-pressing structure 420 is removed, the first edge-pressing structure 410 can be used for edge pressing. Different sizes of dough may be pressed, which is thus suitable for consumers with different appetites.

Referring to FIGS. 3 and 4, the edge pressing structure 400 further includes a third edge-pressing structure 430 disposed within the dough pressing chamber 110. The third edge-pressing structure 430 and the second edge-pressing structure 420 are disposed at an interval, and the small pieces of dough pressed by the third edge-pressing structure 430 are smaller than those pressed by the first edge-pressing structure 410 and the second edge-pressing structure 420 in size. The third edge-pressing structure 430 is disposed to increase user's choices, and the dough pressing machine 10 may press more sizes of small pieces of dough and thus, is suitable for more users with different appetites. It may be understood that, without considering the need for the dough pressing machine 10 to accommodate more users with different appetites, the third edge-pressing structure 430 may also not be configured, as long as the dough pressing machine 10 is provided with the edge pressing structure 400, such solutions should be protected.

It should be noted that, in this embodiment, the third edge-pressing structure 430 is detachably connected to the upper cover 100 and the lower cover 300.

It should be noted that, in other embodiments, the third edge-pressing structure 430 is detachably connected to the upper cover 100.

It should be noted that, in other embodiments, the third edge-pressing structure 430 is detachably connected to the lower cover 300.

Referring to FIGS. 3 and 4, the edge pressing structure 400 is a serrated structure 440 including a first tooth portion 441 disposed on the upper cover 100 and a second tooth portion 442 disposed on the lower cover 300. When the upper cover 100 covers on the lower cover 300, the first tooth portion 441 and the second tooth portion 442 are meshed with each other. The edge pressing structure 400 is configured as a serrated structure 440 by which a large piece of dough may be pressed into small pieces of dough better and more quickly, making it easier for users to press the dough. Furthermore, by configuring the first tooth portion 441 and the second tooth portion 442, when the large piece of dough is placed within the dough pressing chamber 110, and positioned between the upper cover 100 and the lower cover 300, the large piece of dough will be free of deformation due to pressing. It may be understood that, without considering the case of more effort saving and the possibility of deformation, the serrated structure 440 may also not be configured as long as the edge pressing structure 400 may press the large piece of dough into small pieces of dough, such solutions should be protected.

Referring to FIGS. 3 and 4, it should be noted that the edge pressing structure 400 is extended circumferentially along the dough pressing machine 10, and the serrated structure 440 is extended circumferentially and continuously along the edge pressing structure 400.

Referring to FIGS. 3 and 4, it should be noted that the first edge-pressing structure 410, the second edge-pressing structure 420, and the third edge-pressing structure 430 each include a first block 421 and a second block 422.

Referring to FIGS. 3 and 4, one side of the first block 421 close to the second block 422 is a first step structure 423, one side of the second block 422 close to the first block 421 is a second step structure 424, and the first block 421 and the second block 422 are disposed in a cooperation manner; referring to FIG. 2, the first step structure 423 includes a first tabletop 425 and a second tabletop 426, the second step structure 424 includes a third tabletop 427 and a fourth tabletop 428, and when the upper cover 100 covers on the lower cover 300, the first tabletop 425 is abutted against the third tabletop 427, and the second tabletop 426 is abutted against the fourth tabletop 428. By configuring the first step structure 423 and the second step structure 424, small pieces of dough may be pressed via the cooperation between the first tabletop 425 and the third tabletop 427, and may be also pressed via the cooperation between the second tabletop 426 and the fourth tabletop 428, thereby further ensuring that a large piece of dough may be pressed into small pieces of dough by the second edge-pressing structure 420. Meanwhile, after the dough pressing machine 10 is used for a period of time, abrasion will occur on the first tabletop 425 and the third tabletop 427 such that the second tabletop 426 and the fourth tabletop 428 are still able to continue pressing the dough when the first tabletop 425 and the third tabletop 427 may no longer press the dough, thereby extending the service life of the dough pressing machine 10. It is understood that the first step structure 423 and the second step structure 424 may also be not configured as long as small pieces of dough may be pressed via the second edge-pressing structure 420, such solutions should be protected.

Referring to FIG. 2, particularly, in the second edge-pressing structure 420 and the third edge-pressing structure 430, one of the first block 421 and the upper cover 100 is provided with a mounting block 429, and the other is provided with a mounting groove 120. For example, as shown in FIG. 2, the first block 421 is provided with a mounting block 429, the upper cover 100 is provided with a mounting groove 120, and the mounting block 429 is capable of being accommodated within the mounting groove 120 such that the first block 421 is detachably mounted on the upper cover 100. It should be noted that positions of the mounting block 429 and the mounting groove 120 may also be interchangeable, at this time, the mounting block 429 is disposed on the upper cover 100, and the mounting groove 120 is disposed on the first block 421. It is understood that the mounting block 429 and the mounting groove 120 may also be not configured as long as the first block 421 is detachably mounted on the upper cover 100, such solutions should be protected.

Referring to FIG. 2, one of the second block 422 and the lower cover 300 is provided with a mounting block 429, and the other is provided with a mounting groove 120. For example, as shown in FIG. 2, the second block 422 is provided with a mounting block 429, the lower cover 300 is provided with a mounting groove 120, and the mounting block 429 is capable of being accommodated within the mounting groove 120 such that the second block 422 is detachably mounted on the lower cover 300. It should be noted that positions of the mounting block 429 and the mounting groove 120 may also be interchangeable, at this time, the mounting block 429 is disposed on the lower cover 300, and the mounting groove 120 is disposed on the second block 422. It is understood that the mounting block 429 and the mounting groove 120 may also be not configured as long as the second block 422 is detachably mounted on the lower cover 300, such solutions should be protected.

Referring to FIGS. 3 and 4, the upper cover 100 is provided with a first rotating portion 130, and the lower cover 300 is provided with a second rotating portion 310. The first rotating portion 130 and the second rotating portion 310 are disposed on the same side of the upper cover 100 and the lower cover 300, and the first rotating portion 130 and the second rotating portion 310 together form the aforesaid rotating shaft 200.

Referring to FIGS. 3 and 4, one of the first rotating portion 130 and the second rotating portion 310 is provided with a hanger 311, and the other is provided with a hanging hole 131. For example, as shown in FIGS. 3 and 4, the first rotating portion 130 is provided with a hanging hole 131, and the second rotating portion 310 is provided with a hanger 311. The hanger 311 is clamped within the hanging hole 131, and the hanger 311 is capable of rotating within the hanging hole 131 such that the upper cover 100 is capable of rotating relative to the lower cover 300. It should be noted that positions of the hanger 311 and the hanging hole 131 may also be interchangeable, at this moment, the hanging hole 131 is disposed on the second rotating portion 310, and the hanger 311 is disposed on the first rotating portion 130. It is understood that the hanger 311 and the hanging hole 131 may also be not configured as long as the upper cover 100 is capable of rotating relative to the lower cover 300, such solutions should be protected.

Referring to FIGS. 1 and 3, it should be noted that one side of the upper cover 100 away from the first rotating portion 130 is provided with a control portion 132 for manual operation to rotate and open the upper cover 100. The control portion 132 is configured such that users may manipulate the control portion 132 to drive the upper cover 100 for rotation relative to the lower cover 300, thereby facilitating operation and simplifying use. It is understood that the control portion 132 may also be not configured as long as the upper cover 100 is capable of rotating relative to the lower cover 300, such solutions should be protected.

Referring to FIGS. 1 and 3, it should be noted that the control portion 132 is provided with a through hole 133 through which a user may thread a lanyard to hang the dough pressing machine 10. After the user uses the dough pressing machine 10, the user may hang up the dough pressing machine 10 to save space and increase storage space. It is understood that, without considering space saving, the through hole 133 may also be not configured as long as the upper cover 100 is provided with a control portion 132, such solutions should be protected.

When users need to use the dough pressing machine 10, the control portion 132 is operated such that the upper cover 100 rotates relative to the lower cover 300 to open the dough pressing chamber 110. At this time, a large piece of dough may be placed into the dough pressing chamber 110, then the control portion 132 is operated again to press into small pieces of dough.

Although the present disclosure has been described with reference to several exemplary embodiments, it should be understood that the terms used herein are merely for illustrative and exemplary purposes, but are not limited. Since the present disclosure may be embodied in various forms without departing from the spirit or essence of the present disclosure. Hence, it should be understood that the above embodiments are not limited to any of the foregoing details, but shall be interpreted broadly within the spirit and scope defined by the appended claims. Therefore, all the variations and modifications falling within the scope of the claims or equivalents thereof are intended to be covered by the appended claims.

What is claimed is:

1. A dough pressing machine, comprising an upper cover, a rotating shaft, a lower cover, and an edge pressing structure, wherein the upper cover is rotatably connected to the lower cover via the rotating shaft, the upper cover is capable of rotating relative to the lower cover to cover the lower cover to form a dough pressing chamber, the edge pressing structure is disposed within the dough pressing chamber and comprises a first edge-pressing structure and a second edge-pressing structure, the first-edge pressing structure and the second edge-pressing structure are disposed at an interval, and the second edge-pressing structure is detachably mounted on the upper cover and/or the lower cover.

2. The dough pressing machine according to claim 1, wherein the edge pressing structure further comprises a third edge-pressing structure, and the third edge-pressing structure and the second edge-pressing structure are disposed at an interval.

3. The dough pressing machine according to claim 2, wherein the third edge-pressing structure is detachably mounted on the upper cover and/or the lower cover.

4. The dough pressing machine according to claim 1, wherein the edge pressing structure is a serrated structure comprising a first tooth portion disposed on the upper cover and a second tooth portion disposed on the lower cover, and when the upper cover covers the lower cover, the first tooth portion and the second tooth portion are meshed with each other.

5. The dough pressing machine according to claim 4, wherein the edge pressing structure is extended circumferentially along the dough pressing machine, and the serrated structure is extended circumferentially and continuously along the edge pressing structure.

6. The dough pressing machine according to claim 3, wherein the first edge-pressing structure, the second-edge pressing structure, and the third edge-pressing structure each comprise a first block and a second block, one side of the first block close to the second block is a first step structure, one side of the second block close to the first block is a second step structure, and the first block and the second block are disposed in a cooperation manner; the first step structure comprises a first tabletop and a second tabletop, the second step structure comprises a third tabletop and a fourth tabletop, and when the upper cover covers the lower cover, the first tabletop is abutted against the third tabletop, and the second tabletop is abutted against the fourth tabletop.

7. The dough pressing machine according to claim 6, wherein in the second edge-pressing structure and the third edge-pressing structure, one of the first block and the upper cover is provided with a mounting block, and the other is provided with a mounting groove, the mounting block is capable of being accommodated within the mounting groove such that the first block is detachably mounted on the upper cover; and
one of the second block and the lower cover is provided with a mounting block, and the other is provided with a mounting groove, the mounting block is capable of being accommodated within the mounting groove such that the second block is detachably mounted on the lower cover.

8. The dough pressing machine according to claim 1, wherein the upper cover is provided with a first rotating portion, the lower cover is provided with a second rotating portion, the first rotating portion and the second rotating portion are disposed on the same side of the upper cover and the lower cover, one of the first rotating portion and the second rotating portion is provided with a hanger, and the other is provided with a hanging hole, the hanger is clamped with the hanging hole, and the hanger is capable of rotating within the hanging hole such that the upper cover is capable of rotating relative to the lower cover.

9. The dough pressing machine according to claim 8, wherein a control portion is disposed on one side of the upper cover away from the first rotating portion for manual operation to rotate and open the upper cover.

10. The dough pressing machine according to claim 9, wherein the control portion is provided with a through hole for hanging the dough pressing machine.
